(19) United States
(12) Patent Application Publication
(10) Pub. No.: US 2022/0160058 A1
(43) Pub. Date: May 26, 2022

(54) MASK HAVING IMPROVED CAPABILITY OF BLOCKING HARMFUL COMPONENTS

(71) Applicant: DAEYOUNG ENG CO., LTD, Gunsan (KR)

(72) Inventor: Seon-Young KIM, Gunsan (KR)

(21) Appl. No.: 17/111,025

(22) Filed: Dec. 3, 2020

(30) Foreign Application Priority Data
Nov. 26, 2020 (KR) 10-2020-0160824

(51) Int. Cl. A41D 13/11; B01D 39/20

(52) U.S. Cl. CPC A41D 13/1192; B01D 39/2027; B01D 2239/0478; B01D 2239/0442; A41D 13/1161

(57) ABSTRACT

The present disclosure relates to a mask having improved capability of blocking harmful substances, the mask including: a mask main body including at least one main body sheet; and an earring unit which is formed on both side surfaces of the mask main body, and including a coating layer which is formed on at least one surface of the main body sheet and comprises a TiO₂-based nonphotocatalyst that is activated without irradiation of the solar light to decompose the harmful substances, wherein the nonphotocatalyst comprises: titanium dioxide (TiO₂) having a band gap of 3.0 to 3.2 eV; and a transition metal doped with the titanium dioxide, and generates electrons through a spontaneous reaction by making Gibbs free energy change values into negative numbers.

### CROSS-REFERENCE TO RELATED APPLICATIONS

This application claims priority to Korean Patent Application No. 10-2020-0160824 filed on Nov. 26, 2020 in Korea, the entire contents of which are hereby incorporated by reference in their entirety.

### BACKGROUND OF THE DISCLOSURE

### Field of the Disclosure

The present disclosure relates to a mask having improved capability of blocking harmful components by using a nonphotocatalyst coating layer.

### Related Art

The importance of masks capable of preventing infection due to various infectious diseases has been emphasized, and the market thereof is expected to continue to expand.

However, existing masks only perform simple functions of a degree to which fine particles are filtered out using filters only.

Therefore, there is a growing demand for technology of blocking harmful components such as malodorous substances in addition to fine dust through the masks.

### SUMMARY OF THE DISCLOSURE

The present disclosure provides a mask having improved capability of blocking harmful components by using a nonphotocatalyst coating layer.

In an aspect, a mask having improved capability of blocking harmful substances is provided. The mask includes: a mask main body including at least one main body sheet; and an earring unit which is formed on both side surfaces of the mask main body, and includes a coating layer which is formed on at least one surface of the main body sheet and comprises a TiO₂-based nonphotocatalyst that is activated without irradiation of the solar light to decompose the harmful substances, wherein the nonphotocatalyst comprises: titanium dioxide (TiO₂) having a band gap of 3.0 to 3.2 eV; and a transition metal doped with the titanium dioxide, and generates electrons through a spontaneous reaction by making Gibbs free energy change values into negative numbers.

The main body sheet may include: a first main body sheet which comes into contact with a user; and a second main body sheet which comes into contact with the outside, and the coating layer may be formed on an inner surface of the first main body sheet facing the second main body sheet.

The main body sheet may include: a first main body sheet which comes into contact with the user; a third main body sheet which comes into contact with the outside; and a second main body sheet which is positioned between the first main body sheet and the third main body sheet, and the coating layer may be formed on both surfaces of the third main body sheet.

The coating layer may be obtained by drying the nonphotocatalyst solution sprayed onto the first main body sheet after spraying a nonphotocatalyst solution onto the first main body sheet.

The nonphotocatalyst solution may be obtained by performing the steps of: adding an acid catalyst to a solvent including one of distilled water, IPA and ethanol, and primarily stirring the acid catalyst in the solvent; adding a TiO₂ precursor to the solvent, and secondarily stirring the TiO₂ precursor in the solvent; and adding an aqueous solution of precious metal-based and transition metal salts to the solvent after performing the secondary stirring process.

The transition metal may include two or more selected from the group consisting of Zn, Mn, Fe, Cu, Ni, Co, Cr, V, Zr, Mo, Ag, W, Pt, and Au.

The main body sheet may be a polyester-based nonwoven fabric or a polyethylene-based nonwoven fabric.

The main body sheet may be a nonwoven fabric made of polyethylene terephthalate.

The coating layer may be formed also on the second main body sheet, and the coating layers formed on the first and second main body sheets may be formed on areas which are different from each other.

The coating layer may be formed also on the earring unit.

### BRIEF DESCRIPTION OF THE DRAWINGS

FIG. 1 is a perspective view of a mask according to a first embodiment of the present disclosure.

FIG. 2 is a cross-sectional view taken along II-II′ of FIG. 1.

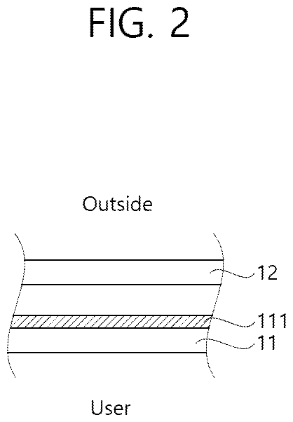

FIG. 3 is a drawing for explaining a mask according to a second embodiment of the present disclosure.

FIG. 4 is a drawing for explaining a mask according to a third embodiment of the present disclosure.

FIG. 5 is a drawing for explaining a mask according to a fourth embodiment of the present disclosure.

### DESCRIPTION OF EXEMPLARY EMBODIMENTS

Hereinafter, a mask according to the present disclosure will be described with reference to the drawings.

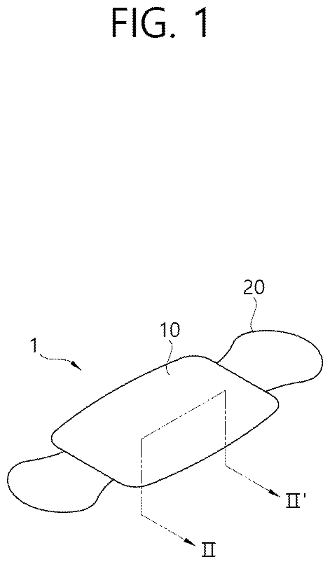

A mask 1 according to a first embodiment of the present disclosure includes a mask main body 10 and an earring unit 20 as shown in FIG. 1.

The mask main body 10 includes a first main body sheet 11, a second main body sheet 12, and a coating layer 111.

When a user wears the mask 1, the first main body sheet 11 is disposed towards the user's face, and the second main body 12 faces outward.

The first main body sheet 11 and the second main body sheet 12 may be a polyester-based nonwoven fabric or a polyethylene-based nonwoven fabric, and mainly block fine dust such as yellow sand. The first main body sheet 11 and the second main body sheet 12 may be made of different materials or have different fine dust blocking performances. Although the present disclosure is not limited thereto, the first main body sheet 11 and the second main body sheet 12 may be a nonwoven fabric made of polyethylene terephthalate.

The coating layer 111 is formed on an inner surface of the first main body sheet 11. In the other embodiment, the coating layer 111 may be formed on an inner surface of the second main body sheet 12 or both of the first main body sheet 11 and the second main body sheet 12.

Further, the mask main body 10 may consist of three or more main body sheets. Further, the mask main body 10 may consist of only one main body sheet.

The coating layer 111 comprises a self-actuated nonphotocatalyst. The self-actuated nonphotocatalyst comprises TiO2, and is activated without light to decompose harmful substances.

The nonphotocatalyst comprises a transition metal doped on titanium dioxide (TiO₂) having a band gap of 3.0 to 3.2 eV. The self-actuated nonphotocatalyst generates electrons through a spontaneous reaction by making Gibbs free energy change values into negative numbers.

The transition metal may be two or more selected from the group consisting of Zn, Mn, Fe, Cu, Ni, Co, Cr, V, Zr, Mo, Ag, W, Pt, and Au.

When the transition metal is doped on titanium dioxide, the transition metal doped on titanium dioxide has strong oxidizing power capable of decomposing harmful gases including volatile organic compounds as well as organic materials by showing catalytic activities even under a nonphoto condition. That is, when doping two or more transition metals having higher energy than that of 2p orbital of oxygen, the transition metals enter a higher level than the valence band so that the level at the top of the valence band is raised, and the transition metals overcome bad gap energy from titanium dioxide, thereby making Gibbs free energy change (ΔG) values of the process of generating electrons into negative numbers (ΔG<0) so that the electrons continue to spontaneously transfer to the surface of titanium dioxide even under a nonphoto condition. Such transferred electrons react with oxygen or water in the air to produce complexed oxygen ions and oxygen radicals, and oxidizing power of the complexed oxygen ions and oxygen radicals effectively removes harmful gases including volatile organic compounds.

The coating layer 111 may be obtained by drying the TiO₂-based nonphotocatalyst solution sprayed onto the first main body sheet 11 after spraying a TiO₂-based nonphotocatalyst solution onto the first main body sheet 11. Further, the coating layer 111 may be obtained by drying the first main body sheet 11 immersed into the TiO₂-based nonphotocatalyst solution after immersing the first main body sheet 11 into the TiO₂-based nonphotocatalyst solution. Specifically, a first main body sheet 11 having the coating layer 111 formed thereon may be obtained by cutting the coating layer-formed main body sheet fabric after forming a coating layer 111 on a main body sheet fabric with a large size.

A nonphotocatalyst solution may be obtained by performing the steps of: adding an acid catalyst to a solvent including one of distilled water, IPA and ethanol, and primarily stirring the acid catalyst in the solvent; adding a TiO₂ precursor to the solvent, and secondarily stirring the TiO₂ precursor in the solvent; and adding an aqueous solution of precious metal-based and transition metal salts to the solvent after performing the secondary stirring process.

The coating layer 111 decomposes or blocks various harmful substances.

First, the coating layer 111 may decompose alcohol, acetic acid, ketone, ester, toluene, xylene, benzene, and ethylbenzene.

The coating layer 111 may decompose malodorous substances, and the malodorous substances may include at least one of hydrogen sulfide, methyl mercaptan, ammonia, methylamine, trimethylamine, formaldehyde, and a volatile organic compound (VOC).

The coating layer 111 not only may decompose NOₓ and SOₓ, but also may sterilize Escherichia coli cells.

In the case of conventional masks, moisture generation caused by breath not only may generate malodor and bacterial multiplication, but also reduces the collection efficiency of fine dust.

Meanwhile, a mask according to the present disclosure not only is given malodor decomposing and removing performance, antibacterial performance and antiviral performance, but also increases the collection efficiency of fine dust regardless of humidity.

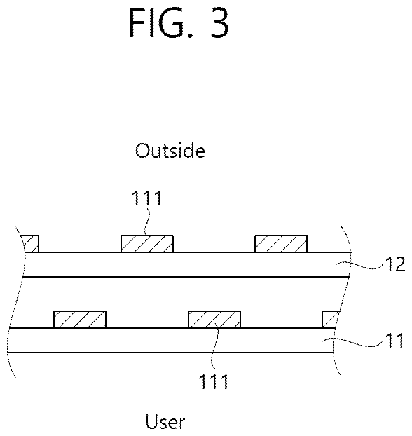

FIG. 3 is a drawing for explaining a mask according to a second embodiment of the present disclosure. A coating layer 111 is formed on both of a first main body sheet 11 and a second main body sheet 12, and is formed on areas which are different from each other. Namely, the coating layers 111 formed on the first main body sheet 11 and the second main body sheet 12 are formed so that they do not face each other.

The coating layer 111 may be formed in the form of scattered points or stripe.

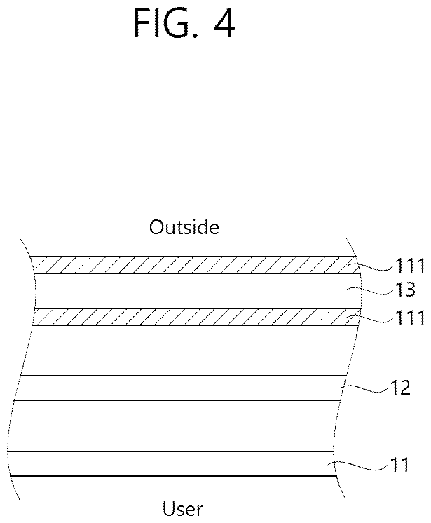

FIG. 4 is a drawing for explaining a mask according to a third embodiment of the present disclosure. The mask main body 10 consists of three layers of a first main body seat 11, a second main body seat 12, and a third main body seat 13. The first main body seat 11 faces a user, and the third main body seat 13 is exposed to the outside. A coating layer 111 is formed on both surfaces of the third main body seat 13.

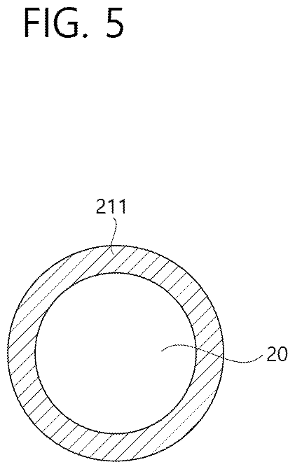

FIG. 5 is a drawing for explaining a mask according to a fourth embodiment of the present disclosure, and shows a cross section of an earring unit 20.

According to the fourth embodiment, a coating layer 211 is formed also on an earring unit 20. The coating layer 211 may be formed by drying the nonphotocatalyst solution sprayed onto the earring unit 20 after spraying a nonphotocatalyst solution onto the earring unit 20.

A mask was manufactured, and an antibacterial test was performed on the mask by the method described above.

The reduction rate of 99.9% was confirmed in 18 hours after inoculating Staphylococcus aureus ATCC 6538 to the mask, and the reduction rate of 48.1% was confirmed in 18 hours after inoculating Klebsiella pneumoniae ATCC 4352 to the mask.

According to the present disclosure, a mask having improved capability of blocking harmful components by using a nonphotocatalyst coating layer is provided.

Although the present disclosure has been described with reference to exemplary embodiments illustrated in the accompanying drawings, the exemplary embodiments of the present disclosure are provided for illustrative purposes only, and it will be understood that those skilled in the art enable various changes and equivalent other embodiments to be made therefrom. Therefore, the true protective scope of the present disclosure should be determined only by the scope of the following claims.

What is claimed is:

1. A mask having improved capability of blocking harmful substances, the mask including:
a mask main body including at least one main body sheet; and
an earring unit which is formed on both side surfaces of the mask main body, and includes a coating layer which is formed on at least one surface of the main body sheet and comprises a TiO₂-based nonphotocatalyst that is activated without irradiation of the solar light to decompose the harmful substances, wherein the nonphotocatalyst comprises:
titanium dioxide (TiO₂) having a band gap of 3.0 to 3.2 eV; and
a transition metal doped with the titanium dioxide, and generates electrons through a spontaneous reaction by making Gibbs free energy change values into negative numbers.

2. The mask of claim 1, wherein the main body sheet includes:
a first main body sheet which comes into contact with a user; and
a second main body sheet which comes into contact with the outside, and the coating layer is formed on an inner surface of the first main body sheet facing the second main body sheet.

3. The mask of claim 1, wherein the main body sheet includes:
a first main body sheet which comes into contact with the user;
a third main body sheet which comes into contact with the outside; and
a second main body sheet which is positioned between the first main body sheet and the third main body sheet, and the coating layer is formed on both surfaces of the third main body sheet.

4. The mask of claim 3, wherein the coating layer is obtained by drying the nonphotocatalyst solution sprayed onto the first main body sheet after spraying a nonphotocatalyst solution onto the first main body sheet.

5. The mask of claim 3, wherein the nonphotocatalyst solution is obtained by performing the steps of:
adding an acid catalyst to a solvent including one of distilled water, IPA and ethanol, and primarily stirring the acid catalyst in the solvent;
adding a TiO₂ precursor to the solvent, and secondarily stirring the TiO₂ precursor in the solvent; and
adding an aqueous solution of precious metal-based and transition metal salts to the solvent after performing the secondary stirring process.

6. The mask of claim 5, wherein the transition metal includes two or more selected from the group consisting of Zn, Mn, Fe, Cu, Ni, Co, Cr, V, Zr, Mo, Ag, W, Pt, and Au.

7. The mask of claim 6, wherein the main body sheet is a polyester-based nonwoven fabric or a polyethylene-based nonwoven fabric.

8. The mask of claim 7, wherein the main body sheet is a nonwoven fabric made of polyethylene terephthalate.

9. The mask of claim 2, wherein the coating layer is formed also on the second main body sheet, and the coating layers formed on the first and second main body sheets are formed on areas which are different from each other.

10. The mask of claim 9, wherein the coating laver is formed also on the earring unit.
